(19) United States
(12) Patent Application Publication
(10) Pub. No.: US 2013/0037352 A1
(43) Pub. Date: Feb. 14, 2013

(54) POWER-GENERATING APPARATUS USING GRAVITY AND MAGNETIC FORCE

(71) Applicant: Seok Su Hong, Seoul (KR)

(72) Inventor: Seok Su Hong, Seoul (KR)

(21) Appl. No.: 13/642,843

(22) PCT Filed: Apr. 20, 2011
(86) PCT No.: PCT/KR2011/002833

§ 371 Date: Oct. 22, 2012

(30) Foreign Application Priority Data
Apr. 20, 2010 (KR) 10-2010-0036215
Apr. 9, 2011 (KR) 10-2011-0032980

(51) Int. Cl. F03G 7/00; H02K 21/00; F03G 3/00; F03G 7/10; H02N 11/00

(52) U.S. Cl. 185/32; 310/152; 74/DIG. 9

(57) ABSTRACT

The present invention relates to a power-generating apparatus using gravity and magnetic force. Rotors are fixed at either side of a main shaft, and heavy weighted bodies are arranged at a plurality of levers which are deployed during a descending operation and folded up during an ascending operation performed in the course of rotation of the rotor, such that the weighted bodies are unbalanced in a horizontal direction. An arch-shaped magnetic levitation unit is arranged adjacent to and above the rotors. The heavy weighted body located at the position of mechanical energy is levitated by means of the magnetic force from the magnetic levitation unit at a starting point of the magnetic force, such that a wheel is brought into contact with and rolls on a rail of a magnetic support, and the heavy weighted body levitates in the air at the position of mechanical energy. Then, the weighted body moves at a speed faster than the rotating speed of the rotors by means of a rotational propulsion member of a driving motor, such that the folded lever can be deployed and the heavy weighted body falls downward by itself at an ending point of the magnetic force, at which the magnetic force is weakened. Thus, the weight arranged at the edge of the rotor increases power and torque in the direction of gravity at the position of maximum gravity, and converts gravity-based kinetic energy into mechanical energy so as to rotate the rotors and the main shaft and thus generate power.

### TECHNICAL FIELD

The present invention relates to a power-generating apparatus using gravity and magnetic force, and more particularly, to a power-generating apparatus, which generates power by generating a weight unbalance between heavy weighted bodies arranged at end portions of a plurality of levers which are restrictedly unfolded and folded up in the course of rotation of rotors, making the heavy weighted bodies be levitated by using gravitation of a magnetic levitation unit arranged above the rotors, making the heavy weighted bodies move by a rotational propulsion member, making the heavy weighted bodies descend in order for power and torque to be increased in the direction of gravity at the position of maximum gravity to convert gravity-based kinetic energy into mechanical energy, and thus, rotating the rotors and a main shaft.

### BACKGROUND ART

To generate power, generally, an internal combustion engine burning fuel such as diesel oil, gasoline, gas or the like, or a steam engine mainly using fossil fuel are used, and thus, fumes or other noxious gases are generated.

Moreover, at present, related art generating apparatus or systems, which generate energy sources maintaining civilization, use natural environment and natural resources such as fossil fuel, nuclear power, solar heat, wind power, water power, hydrogen, tidal power or the like, but, in order to use them, the natural environment has to be developed in order for time conditions or spatial conditions suitable for conditions of the generating system to be formed, or for infrastructures suitable for the system to be built.

Because of the environmental development, another ambient environment or ecosystems are destroyed, and thus, many social/economic costs have to be paid.

### DISCLOSURE OF INVENTION

Accordingly, the present invention is directed to a power-generating apparatus using gravity and magnetic force, which substantially obviates one or more problems due to limitations and disadvantages of the related art. An aspect of the present invention is directed to provide a power-generating apparatus using gravity and magnetic force, which generates continued torque by using magnetic force and gravity-based kinetic energy, power of which may be directly used, power of which may be linked to generator to generate electric power, and thus, by which energy is generated to be effectively used in industrial settings.

To achieve these and other advantage and in accordance with the purpose of the invent ion, as embodied and broadly described herein, there is provided a power-generating apparatus using gravity and magnetic force, which comprises: a rotor which is formed into a circular plate shape and is fixed at either side of a main shaft, and which includes a driving body which is formed into a radial shape, a driving support which is formed in one side of the driving body, and a driving spring 23 which is formed in an end portion of the driving support; a lever arm which is coupled to a coupling part of the driving body and the driving support; a lever which is coupled to the lever arm by a hinge, and restrictedly folded up and unfolded in the course of rotation of the rotor; a lever connecting bar which is coupled to one side of the both levers, and is integrally formed into a ‘ [symbol] ’ shape; a weighted body which is coupled to the lever connecting bar through a through hole and formed into a lengthily extending shape; two wheels which are inserted into the center portion of the weighted body at a certain interval, protrudes a little and are coupled to be freely rotated; a magnetic levitation unit comprising a magnetic support frame which is arranged adjacent to and above the rotor with an arch shape, a plurality of magnetic supports which are placed along a curved surfaced of a center of the magnetic support frame, a plurality of magnetic fixing parts which are coupled to the magnetic support in order for magnet to be mounted, and two lines of rails which are formed along a curved surface of the center of bottom side of the magnetic support; a driving motor which is mounted on the magnetic levitation unit; a rotational belt which is engaged with a shaft gear, which is coupled to a propulsion shaft coupled to the driving motor by a time belt, to rotate; and a rotational propulsion member which is coupled to the rotational belt and formed into a ‘L’ shape, wherein, the weighted body levitated by magnetic force is moved by the rotational propulsion member to make the folded lever be unfolded, the weighted body gently presses the driving spring to descend in the course of falling, and the rotor and the main shaft rotate by a weight unbalance of the left-and-right sides of the rotor, the weight unbalance occurring by a length difference of the weighted bodies which are located at left side and right side of the rotor.

Therefore, the power-generating apparatus using gravity and magnetic force according to the present invention increases the torque by using a weight unbalance between a left side and a right side and a power inputted for an initial driving to be effectively used in industrial settings.

### Advantageous Effects

According to the embodiments of the present invention, because the present invention can endlessly gain rotation power if a rotational propulsion member connected to a driving motor moves a levitated weighted body by a little power in the initial stages, the present invention can be usefully applied to industrial settings in quality, can minimize investment costs, can provide a high efficiency power-generating apparatus to enhance the usefulness of the apparatus, can prevent environmental pollution, which is incurred by a use of fossil fuel, by using the low-carbon clean energy, and can significantly lighten an effort for securing energy to make progressive changes in an industry a personal life.

### BRIEF DESCRIPTION OF DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a front view illustrating an operation state of a power-generating apparatus using gravity and magnetic force according to a present invention;

FIG. 2 is a front view illustrating a rotation state of a weighted body arranged at an end portion of a lever of a rotor according to the present invention;

FIG. 3 is a perspective view illustrating a connection state between rotors of both sides and a lever and a lengthily extending state of the weighted body according to the present invention;

FIG. 4 is an exemplary diagram illustrating a mounting state of a plurality of magnets mounted along an arch-shaped curved surface of a magnetic levitation unit according to the present invention;

FIG. 5 is an exemplary diagram illustrating two lines of rails formed in bottom side of a arch-shaped curved surface of a magnetic support according to the present invention;

FIG. 6 is an exemplary diagram illustrating a time belt and a rotational propulsion member, which are mounted along a curved surface of either side of the magnetic support, according to the present invention;

FIG. 7 is an exemplary component diagram illustrating a connection state of the weighted body and a configuration a wheel according to the present invention;

FIG. 8 is an exemplary diagram illustrating a connecting shape of a driving support and a spring housing in the driving body of the rotor according to the present invention;

FIG. 9 is an exemplary component diagram illustrating a connection state between a main shaft supported by both supports and a rotor according to the present invention;

FIG. 10 is an exemplary diagram illustrating different rotation radiuses depending on rotations of a lever arm and a weight body according to the present invention;

FIG. 11 is an exemplary diagram illustrating a changing state of a weight of a weighted body depending on a rotation angle according to the present invention;

FIG. 12 is an exemplary diagram illustrating gravitation portions of a magnet divided along an arch-shaped curved surface of a magnetic levitation unit according to the present invention;

FIG. 13 is an exemplary diagram illustrating a standard point of potential energy of each of a rotor and a weighted body according to the present invention;

FIG. 14 is an exemplary diagram illustrating a car with a power-generating apparatus according to the present invention; and

FIG. 15 is a front view illustrating a rotor to which a lever consisting of a plurality of nodes is connected according to another embodiment of the present invention.

### MODES FOR CARRYING OUT THE INVENTION

Reference will now be made in detail to the exemplary embodiments of the present invention, examples of which are illustrated in the accompanying drawings. Wherever possible, the same reference numbers will be used throughout the drawings to refer to the same or like parts. Hereinafter, the power-generating apparatus using gravity and magnetic force according to the embodiments of the present invent ion will be described in detail with reference to the accompanying drawings.

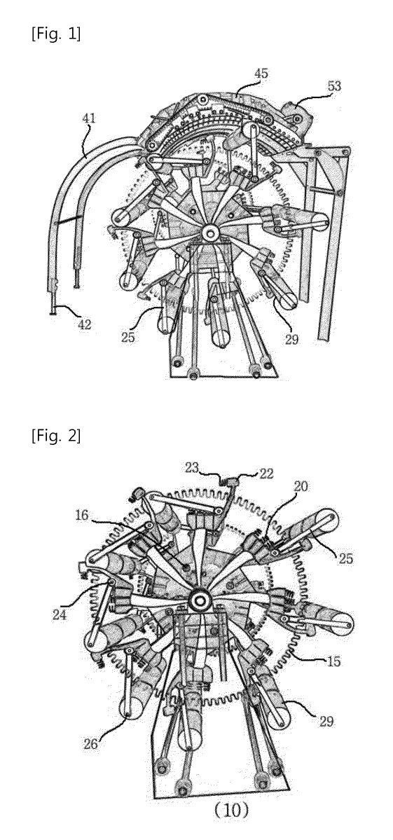

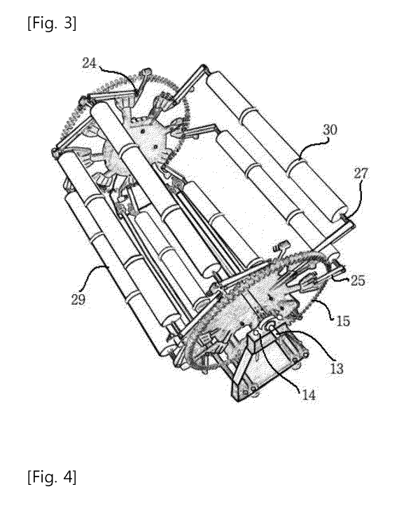

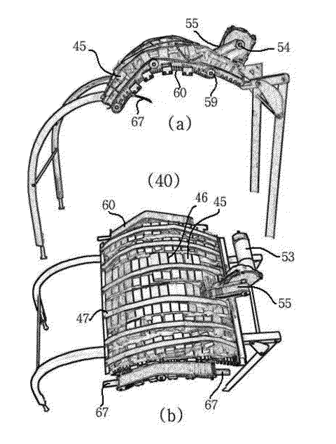

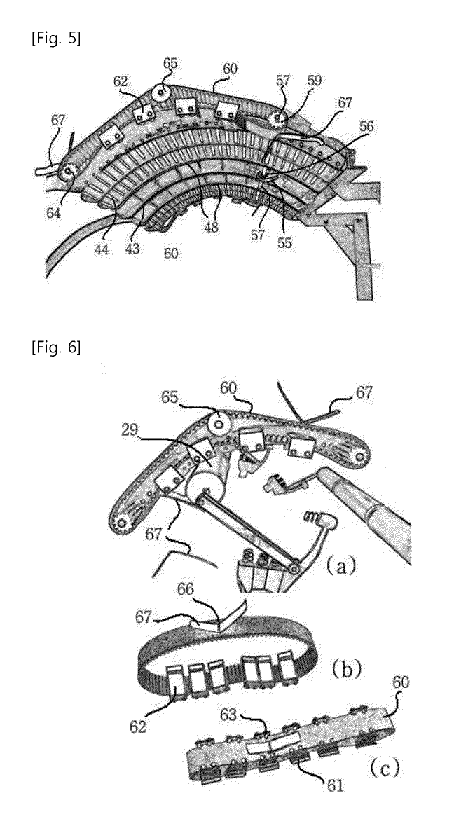

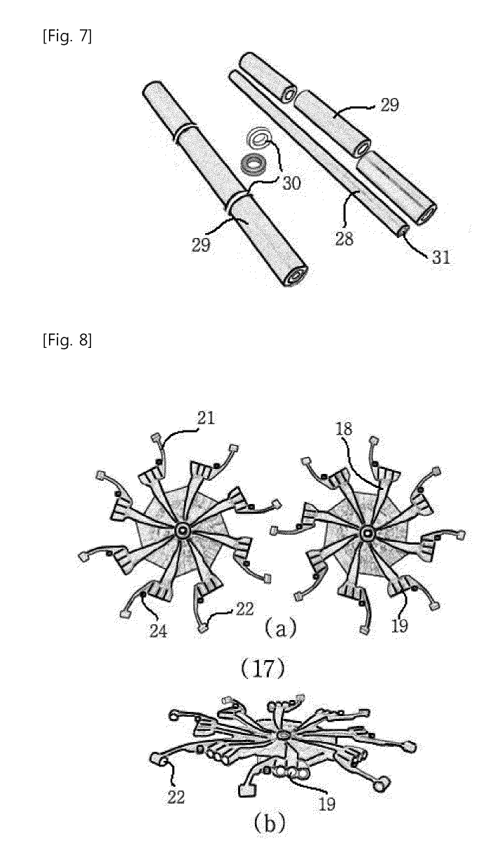

The accompanying drawings, which are included to provide a further understanding of the invention and are incorporated in and constitute a part of this application, illustrate embodiments of the invention and together with the description serve to explain the principle of the invention. In the drawings: FIG. 1 is a front view illustrating an operation state of a power-generating apparatus using gravity and magnetic force according to a present invention, FIG. 2 is a front view illustrating a rotation state of a weighted body arranged at an end portion of a lever of a rotor according to the present invention, FIG. 3 is a perspective view illustrating a connection state between rotors of both sides and a lever and a lengthily extending state of the weighted body according to the present invention, FIG. 4 is an exemplary diagram illustrating a mounting state of a plurality of magnets mounted along an arch-shaped curved surface of a magnetic levitation unit, FIG. 5 is an exemplary diagram illustrating two lines of rails formed in bottom side of a arch-shaped curved surface of a magnetic support according to the present invention, FIG. 6 is an exemplary diagram illustrating a time belt and a rotational propulsion member, which are mounted along a curved surface of either side of the magnetic support, according to the present invention, and FIG. 7 is an exemplary component diagram illustrating a connection state of the weighted body and a wheel according to the present invention.

As shown in the accompanying drawings, the power-generating apparatus includes a rotor 17 which is formed into a circular plate shape, and fixed at either side of a main shaft 13, and, the rotor 17 includes a driving body 18 which is formed into a radial shape, a driving support 21 which is formed in one side of the driving body 18, and a driving spring 23 which is formed in an end portion of the driving support 21.

The power-generating apparatus according to the present invention includes a magnetic levitation unit 40 including a plurality of magnets 45 which are mounted on a magnetic fixing part 44 and a plurality of magnetic support 43 which is placed along a curved surface of a middle part of a magnetic support frame 41 arranged adjacent to and above a rotation apparatus 10, the magnet 45 being mounted at a certain arrangement, and the present invention is driven by interaction between the two apparatus.

As shown in a portion (a) and (b) of FIG. 9, supports 12 are coupled on either side of a plurality of support fixing bars 11, main bearing 14 is coupled on each of the support fixing bars 11, a main shaft 13 is coupled to centers of the main bearings 14, and each of the rotors 17 is coupled to either end portion of the main shaft 13.

A lever arm 24 is formed in one side of each of the driving bodies 18 which are radially formed in the circular plate-shaped rotor 17 which is fixed at either side of the main shaft 13. The lever 25 is coupled to the lever arm 24 by using a hinge, and the lever 25 is restrictedly unfolded and folded up. A lever connecting bar 27 is coupled to an end portion of the lever 25, and the weighted body 29 which is formed into a lengthily extending shape with a weight, is connected to the lever connecting bar 27 through a through hole 31.

As shown in FIG. 2, the lever arm 24 is formed in an end portion of the driving body 18 a plurality of which are radially formed in the rotor 17 fixed in each side of the main shaft 13, the lever 25 is coupled to the lever arm 24 by using the hinge, a lever connecting bar 27 is coupled to a lever connecting part 26 of the lever 25, and thus, a ‘ [symbol] ’ shape is formed.

Therefore, the two levers 25 respectively coupled to the lever arm 24 formed in each of the rotors 17 are formed into a ‘ [symbol] ’ shape, and the lever 25 is unfolded when the rotor 17 descends downward, and the lever 25 is folded when the rotor 17 ascends upward.

Moreover, the lengthily extending-shaped weighted body 29 is coupled to the lever connecting bar 27 through the through hole 31, and because the both levers 25 are unbalanced, the weighted body 29 may generate power through an outputting gear 15 which is coupled to the rotor 17 by a fixing bar 16.

As shown in a portion (a) and (b) of FIG. 8, FIG. 8 is an exemplary diagram illustrating a connecting shape of a driving support 21 and a spring housing 19 in the driving body 18 of the rotor 17 according to the present invention, and a plurality of driving bodies 18 are radially formed in the circular plate-shaped rotor 17, the spring housing 19, in which a groove is formed in order for a spring to be vertically inserted into the groove, is formed in an end portion of the driving body 18, and a buffer spring 20 is coupled to the spring housing 19.

Moreover, the driving spring housing 22 is formed in an end portion of the driving support 21, which is formed in one side of the spring housing 19, in order for a spring to be vertically inserted into the driving spring housing 22, and a driving spring 23 is coupled to the driving spring housing 22.

Therefore, the lever 25, which is coupled to the lever arm 24 by a hinge, is repeatedly brought into contact with the buffer spring 20 and the driving spring 23 when the lever 25 is restrictedly rotating depending on a rotation angle during a rotation process, and thus, an unbalance of the moment continuously occurs.

Moreover, the folded lever 25 is brought into contact with the buffer spring 20 of the spring housing 19, and the unfolded lever 25 is brought into contact with the driving spring 23 of the driving spring housing 22, and thus, the rotor 17 is driven by a weight of the weighted body 29 coupled to the lever connecting bar 27.

As shown in FIG. 3, the weighted body 29, which is coupled to the lever connecting bar 27 through the through hole 31 so as to be freely rotated, and which is coupled to a weighted body fixing bar 28, is magnetic, can rotate the rotor 17 during descending in gravity direction, and is formed into a lengthily extending shape, and thus, a weight may be increased by the weighted body 29, and the heavier the weighted body 29, the stronger the power is.

As the length of the lever 25, which is folded and unfolded depending on a rotation of the rotor 17, is lengthened, a weight difference between the left side of the rotor 17 and the right side of the rotor 17 is relatively increased.

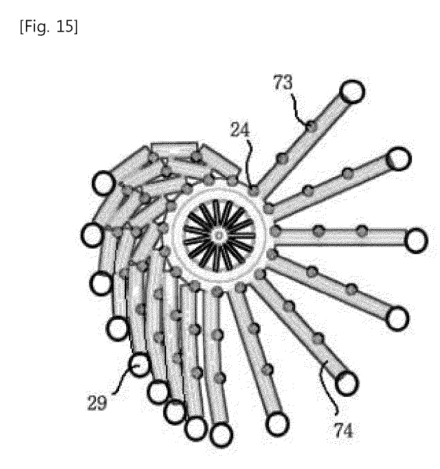

As shown in FIG. 15, FIG. 15 is a front view illustrating a rotor to which a lever consisting of a plurality of nodes is connected according to another embodiment of the present invention, and the lever 25 connected to the lever arm 24 includes a plurality of lever hinges 73 which perform a function of a hinge, and a plurality of lever nodes 74 which are coupled to the lever hinges 73, and the lever 25 may be restrictedly unfolded and folded depending on an angle during a rotation process of the rotor 17.

As a length of the lever 25 is lengthened, outputted power or torque is increased, but if the length of the lever 25 is unnecessarily lengthened, a problem such as an installation space or the like occurs, and therefore, the length of the lever 25 may be designed to be suitable for a used place or used space.

The weighted body 29, which lengthily extends and is made of a magnetic material, and the magnet 45 mounted on the magnetic support 43 along a curved surface have mutually different polarities (N polarity or S polarity), and the weighted body 29 and the magnetic support 43 are disposed to face each other.

Moreover, the weighted body 29 may be formed of a material, which has a relatively larger weight in comparison with a volume, such as steel or the like.

As the number of the weighted body 29 located at edge of the rotor 17 is increased, the rotor 17 may be satisfactorily rotated.

When the magnetic force of the magnet 45, which is mounted along the curved surface formed by the magnetic support 43 and the magnetic fixing part 44, is weak, if an electromagnet is mounted, any heavy weighted body 29 having a weight of several tons may be levitated by gravitation.

As shown in FIG. 7, the three weighted bodies 29 lengthily extending is coupled to a weight body fixing bar 28, a wheel 30 is inserted into between the weighted bodies 29, the wheel 30 protrudes a little at a certain interval, the wheel is coupled to be freely rotated, and the weighted body 29 and the wheel 30 are coupled to the lever connecting bar 27 through the through hole 31.

Therefore, the lever 25, which is connected to the weighted body 29 and is disposed at one side ascending depending on a rotation angle, is folded, and the lever 25, which is disposed at the other side descending depending on a rotation angle, is unfolded, and thus, an unbalance of the moment continuously occurs.

Because of a difference between one length from the center of the main shaft 13 to the left side and another length from the center to the right side, the difference being generated by the weighted body 29 coupled to the end portion of the both lever 25, a weight is greatly changed.

As shown in a portion (a) of FIG. 4, the magnetic levitation unit 40, which is formed into an arch shape, is arranged adjacent to and above the rotation apparatus 10, and is in the area of magnetic field, includes the magnetic support 43 and the magnetic fixing part 44 which are formed in order for the magnet 45 to be mounted along the arch-shaped curved surface.

As shown in a portion (b) of FIG. 4, a plurality of the magnets 45 are mounted along the curved surface which is formed by the magnetic support 43 and the magnetic fixing part 44, and the magnets 45 with multipolarity are arranged in order for the magnetic field of gravitation to be constant.

Between the magnets 45, which have multipolarity and are arranged at a certain interval along the arch-shaped curved surface formed by the magnetic support 43 and the magnetic fixing part 44, a transition blocking part 46 blocking a transition of magnetic force is provided to prevent the magnetic force from being concentrated, and the magnets 45 are coupled by using a magnet fixing string 47.

A plurality of the magnets 43, which are mounted along the curved surface of the magnetic support 43 and the magnetic fixing part 44, may be an electromagnet

As shown in FIG. 5, two lines of rails 48, whose shape are the same as that of the train rails, are formed in a middle portion of a bottom of the arch-shaped curved surface of the magnetic support 43 and the magnetic fixing part 44 of the magnetic levitation unit 40 to protrude a little, and the two wheels 30 of the weighted bodies 29 levitated by gravitation of the magnet 45 are brought into contact with and rolls on the rails when the wheels 30 are being in the air.

As shown in FIG. 1, the magnetic levitation unit 40, which is arranged adjacent to and above the rotation apparatus 10 in the area of the magnetic field and is formed into an arch shape, will be described below.

As shown in a portion (a) of FIG. 4, the weighted body 29 is levitated by the gravitation of the magnet 45, which has multipolarity and is arranged at a certain interval along the curved surface formed by the magnetic support 43 and the magnetic fixing part 44.

The levitated weighted body 29 is moved at a faster speed than a rotation speed of the rotor 17 by a rotational propulsion member 67 which is driven by initial power inputted into a driving motor 53, and thus, the moving speed of the weighted body 29 may keep step with the rotation speed of the rotor 17.

The magnetic levitation unit 40 includes a magnet support frame 41 which supports the magnetic levitation unit 40, the magnetic support 43 which is formed into an arch shape, and the magnetic fixing part 44 which fixes the magnet 45, and an adjacent gap between the rotation apparatus 10 and the magnetic levitation unit 40 may be adjusted by a adjusting bolt 42 which adjusting a height of the magnet support frame 41.

The magnetic levitation unit 40 includes a starting point of the magnetic force 49 at which the gravitation of the magnet 45 is generated, a medium point of the magnetic force 50 which is formed in the middle of the curved surface, and an ending point of the magnetic force 51 in which the gravitation gradually becomes weak after the medium point of the magnetic force 50, along the arch-shaped curved surface, gravitation of the magnet 45 becomes more weak in a descending point of weighted body 93 and the levitated weighted body 29 falls downward by itself just after the levitated weighted body 29 comes into an enticing point of the magnetic force 52.

The gap between the weighted body 29 and the rotation apparatus 10 becomes narrow in the starting point of the magnetic force 49 as like the weighted body 29 is brought into close contact with the rotation apparatus 10, and the gap between the weighted body 29 and the rotation apparatus 10 gradually becomes larger along the curved surface of the magnetic support 43 of the starting point of levitation of weighted body 92.

Therefore, if the folded weighted body 29 is brought into contact with the starting point of the magnetic force 49, magnetic field is generated, and thus, the weighted body 29 is levitated by the gravitation of the magnet.

At this point, the heavy weighted body 29, a load of which is supported by the rotor 17, is levitated, and thus, the weight of the weighted body 29 is transferred to the magnetic levitation unit 40 to be supported.

The wheel 30 of the levitated weighted body 29 is brought into contact with the rail 48 of the magnetic support 43 and rolls on the rails 48 along the arch-shaped curved surface.

As shown in a portion (a) of FIG. 6, the driving motor 53 disposed at the magnetic levitation unit 40 rotates a time belt 55 engaged with a motor gear 54 fixed at the driving motor 53 by using an initial input power, and thus, rotates a propulsion shaft 57 fixed at an input gear 56 coupled to the time belt 55.

A shaft gear 59 is fixed at both end sides of the propulsion shaft 57 supported by a propulsion bearing 58 respectively formed in both sides of the magnetic levitation unit 40, and a rotational belt 60 is engaged with the shaft gear 59 to rotate, and, when the rotational belt 60 rotates along the curved surface, an upper belt of the rotational belt 60 is supported by the shaft gear 59, the belt gear 64 and a middle gear 65 which is disposed inside the rotational belt 60 in a middle portion of the rotational belt 60, and thus, an arch-shaped curved surface is formed.

As shown in a portion (b) of FIG. 6, a lower belt of the rotational belt 60 is supported by a belt wheel 63 disposed at a belt support 62 fixed by a plurality of belt fixing parts 61 placed in a lower portion of outside the rotational belt 60 along the curved surface. Therefore, when the rotational belt 60 rotates, the upper belt and the lower belt of the rotational belt 60 rotate along the arch-shaped curved surface.

A portion (c) of FIG. 6 illustrates a lower portion of the rotational belt 60 shown in a portion (b) of FIG. 6 and as shown in a portion (c) of FIG. 6, because a plurality of the belt wheels 63 freely rotating is installed to support the both edge sides of the rotational belt 60, when the rotational belt 60 rotates along a curved surface, frictional force between the rotational belt 60 and the belt wheel 63 does not occur, and thus, the rotational belt 60 smoothly rotates.

A propulsion member connecting part 66, which is a folded portion of each of a plurality of rotational propulsion members 67 formed into a ‘L’ shape, is coupled to a center line of the outside of the rotational belt 60, and the belt is supported by the belt wheel 63 of the belt support 62 along the curved surface, and thus, when the rotational belt 60 rotates, the rotational propulsion member 67 as well as the rotational belt 60 can freely rotate.

Therefore, in the course of rotation of the rotational belt 60, a plurality of the rotational propulsion members 67 continuously move the levitated weighted body 29 in a certain direction by using an initial input small power.

Moreover, the rotational propulsion member 67 drops the weighted body 29 near the ending point of the magnetic force 51, and, at the same time, another rotational propulsion member 67 continuously moves the levitated weighted body 29.

When the weighted body 29 descends, the folded lever 25 is unfolded, and, at the same time, the unfolded lever 25 is brought into contact with the driving spring 23, and thus, the unfolded lever 25 gently presses the driving spring 23, thereby the torque of the rotor 17 being increased.

In the present invention, another rotational belt 60, which is placed in a center between the rails 48, other than the rotational belt 60, which is placed at either side of the magnetic support 43 along the curved surface of the magnetic support 43, may be further included.

FIG. 8 is an exemplary diagram illustrating a driving support and a spring housing formed in a driving body of a rotor according to the present invention, and the rotor 17 includes the buffer spring 20 which is inserted into the spring housing 19 coupled to each of the end portions of a plurality of the driving body 18 radially formed from the center of the rotor 17, and the driving spring 23 which is inserted into the driving spring housing 22 formed in the driving support 21 formed in edge of the rotor 17

Therefore, when the lever 25 is folded, the lever 25 is brought into contact with the buffer spring 20, and when the lever 25 is unfolded, the lever 25 is brought into contact with the driving spring 23, and thus, a shock generated by a contact between metals is moderated, thereby the torque of the rotor 17 being increased.

Moreover, a spring to absorb a shock and an elasticity member are further included.

FIG. 9 is an exemplary diagram illustrating a connection state between a main shaft 13 supported by both supports 12 and a rotor 17 according to the present invention, and two rotors 17 are respectively coupled to either side of the main shaft 13 supported by the both support 12 fixed by the support fixing bar 11.

The driving method of a power-generating apparatus using gravity and magnetic force according to the present invention will be described below.

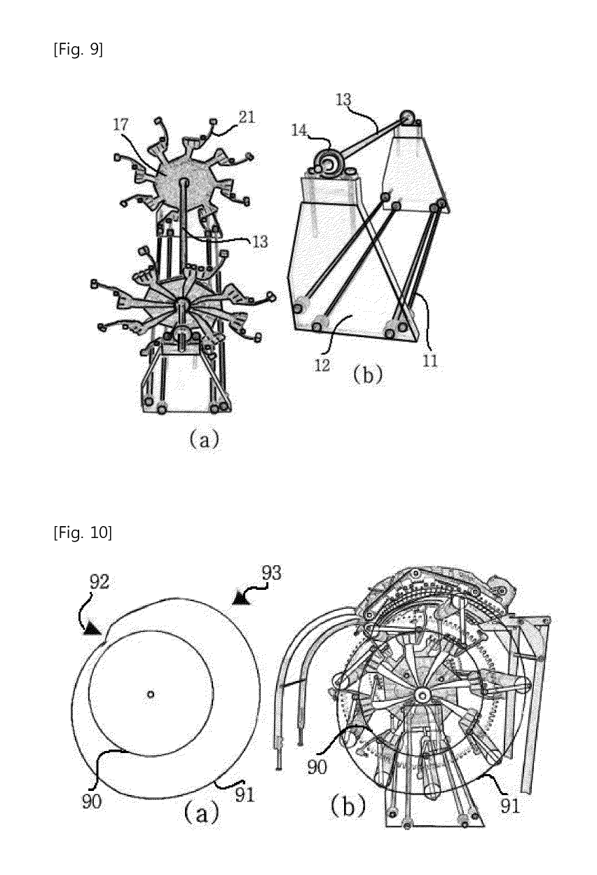

First, as shown in FIG. 1 according to the first embodiment of the present invention, FIG. 10 is an exemplary diagram illustrating different rotation radiuses depending on rotations of a lever arm and a weight body according to the present invention, and a rotation radius of lever arm 90 of the lever arm 24 is constant when the rotor 17 rotates with respect to the center of the main shaft 13.

However, a rotation radius of the weighted body 91 of the weighted body 29 coupled to an end portion of the lever 25 is very much changed, that is, two rotation radius are overlapped in a starting point of levitation of weighted body 92 of the starting point of the magnetic force 49 in which the weighted body 29 is levitated by the magnetic force, and the two rotation radius are separated just after the overlapping, and then, a rotation radius of the weighted body 91 is rapidly changed.

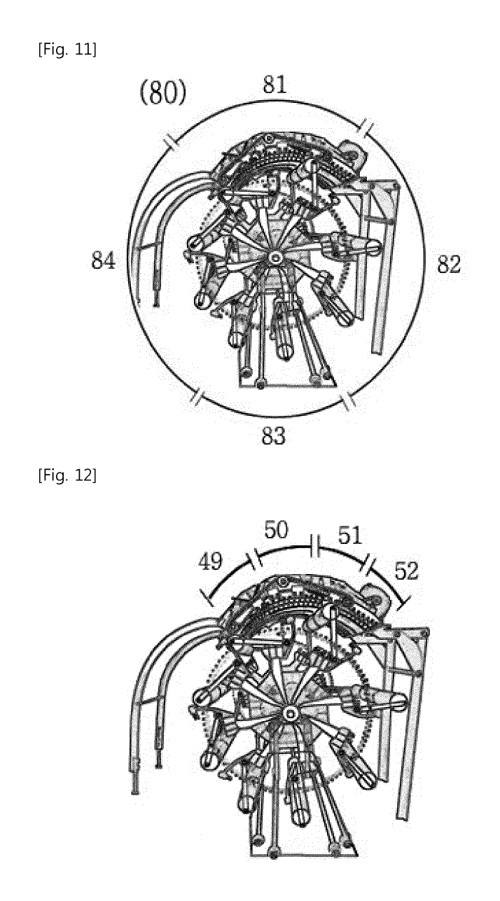

According to the second embodiment of the present invention, FIG. 11 is an exemplary diagram illustrating a changing state of a weight of a weighted body depending on a rotation angle according to the present invention, and each of the energy 80 depending on a rotation angle of the weighted body will be described below.

The levitation of the weighted body 29 by the magnetic force starts from the starting point of levitation of weighted body 92 of the starting point of the magnetic force 49, and then, the weighted body 29 is immediately placed in a position of the potential energy, the weighted body 29 is moved to the descending point of weighted body 93 when the weighted body 29 is being levitated, and thus, the position of potential energy 81 is widely formed.

Because the magnetic force becomes weak in the descending point of weighted body 93, the weighted body 29 falls downward by itself, and thus, the driving spring 23, which is formed in the edge of the rotor 17, is gently pressed, power and torque are increased, and the weighted body 29 descends from the position of maximum gravity, and thus, a gravity-based kinetic energy is generated in the position of gravity-based kinetic energy 82, and as the gravity-based kinetic energy is converted into mechanical energy, the rotor 17 and the main shaft 13 rotates, thereby power being generated, and here, the power is the energy which the present invention want to gain.

Therefore, if the rotational propulsion member 67 moves the levitated heavy weighted body 29 in the position of potential energy 81, the weighted body 29 descends by a gravity operation, and thus, the rotor 17 may endlessly rotate.

Also, the weighted body 29 descends at the acceleration of gravity, and thus, the weighted body 29 continuously gains the rotational inertia energy in the position of rotational inertia energy 83.

However, if the weighted body 29 passes the position of rotational inertia energy 83, the weighted body 29 loses propulsion, and the weighted body 29 instantaneously stops in the position of mechanical energy 84, and because the lever 25 is folded by itself, the moment becomes short, and thus, the weight becomes light in comparison with an opposite side, thereby energy consumption being decreased in the course of ascending.

According to the third embodiment, FIG. 12 is an exemplary diagram illustrating gravitation portions of a magnet divided along an arch-shaped curved surface of a magnetic levitation unit according to the present invention, and a description for the magnetic force formed along the arch-shaped curved surface between the rotation apparatus 10 and the magnetic levitation unit 40 will be described below. The magnetic force is constant in the starting point of the magnetic force 49, at which the magnetic force of a plurality of magnets 45 starts, and the medium point of the magnetic force 50, at which the magnetic force is middle, and the gap between the rotation apparatus 10 and the magnetic levitation unit 40 is narrow in the starting point of the magnetic force 49 as like the weighted body 29 is brought into contact with the magnetic levitation unit 40, and, the gap progressively grows toward the medium point of the magnetic force 50.

However, the weighted body 29 is moved to the ending point of the magnetic force 51, in which the magnetic force progressively becomes weak, and the enticing point of the magnetic force 52, in which the magnetic force become more weak, and, at the same time, the weighted body 29 falls downward by itself to gently press the driving spring 23 to descend.

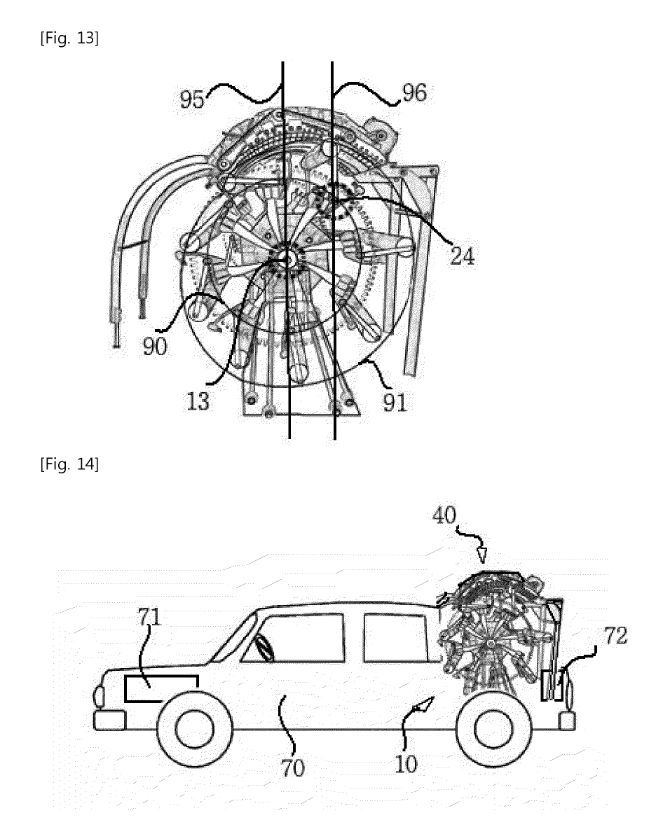

Also, according to the fourth embodiment, FIG. 13 is an exemplary diagram illustrating a standard point of potential energy of each of a rotor and a weighted body according to the present invention, and potential energy of a rotor 17, which is supported by the main shaft 13 and rotates, rotates with respect to a standard point of potential energy of a rotor 95.

However, a standard point of potential energy of a weighted body 96, as shown in FIG. 13, passes the standard point of potential energy of a rotor 95 by the rotational propulsion member 67, which makes the folded lever 25 coupled to the lever arm 24 of the rotor 17 be unfolded, and moves the weighted body 29 at the speed faster than the rotation speed of the rotor 17, and thus, each of the rotor 17 and the weighted body 29 has a different standard point of potential energy, performs a different function, and the rotor 17 and the weighted body 29 are driven at the same time.

Therefore, the rotor 17 rotates with respect to the main shaft 13 with a constant radius in the course of rotation of the rotor 17, but the position of a plurality of the levers 25 and the weighted bodies 29, which restrictedly rotate, is changed when the levers 25 and the weighted bodies 29 rotate by different gravitational action depending on a rotation angle.

Because a weight unbalance, which can rotate the rotor 17, is generated just after the weighted body 29 having a weight passes the standard point of potential energy of a weighted body 96 by the rotational propulsion member 67, the weighted body 29 increases power and torque in the course of descending in the direction of gravity at the position of maximum gravity, and converts gravity-based kinetic energy 82 into mechanical energy so as to rotate the rotor 17 and the main shaft 13 and thus, generates power.

According to the fifth embodiment, FIG. 14 is an exemplary diagram illustrating a car with a power-generating apparatus according to the present invention, and the car 70 with the power-generating apparatus according to the present invention will be described below. The power-generating apparatus according to the present invention and a generator 72 are located at a trunk or the like of the rear position of the car 70, and a storage battery 71 is mounted in a front bumper.

The wheel of the car 70 is driven by a transmission by directly using the power generated from the power-generating apparatus according to the present invention, and thus, the car can be run.

Moreover, when the car is parked or is not used, the generator 72 connected to the power-generating apparatus generates electric power and charges the storage battery 71, and thus, when the car runs at high speed, the car may run by directly using the power generated the apparatus and the electric power, and when the car runs at low speed, the car may run by directly using the power generated the apparatus.

Also, the power-generating apparatus according to the present invention constantly generates power by using the initial input power without a recharge.

Moreover, the power-generating apparatus according to the present invention may be applied to the power-generating source of a ship, a train, a portable generator or the like as well as a general generator.

The above-described power-generating apparatus using gravity and magnetic force according to the present invention, finally outputs the power through the outputting gear 15 which is coupled to the rotor 17 by the fixing bar 16 and supported by the main shaft 13.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The power-generating apparatus using gravity and magnetic force according to the present invention can directly use the torque generated by the power or transfer the power to the generator so as to generate the electric power.

| | |
|---|---|
| 10: rotation apparatus | 11: support fixing bar |
| 12: support | 13: main shaft |
| 14: main bearing | 15: outputting gear |
| 16: fixing bar | 17: rotor |
| 18: driving body | 19: spring housing |
| 20: buffer spring | 21: driving support |
| 22: driving spring housing | 23: driving spring |
| 24: lever arm | 25: lever |
| 26: lever connecting part | 27: lever connecting bar |
| 28: weight body fixing bar | 29: weighted body |
| 30: wheel | 31: through hole |
| 40: magnetic levitation unit | 41: magnet support frame |
| 42: adjusting bolt | 43: magnetic support |
| 44: magnetic fixing part | 45: magnet |
| 46: transition blocking part | 47: magnet fixing string |
| 48: rail | 49: starting point of the magnetic force |

50: medium point of the magnetic force
51: ending point of the magnetic force
52: enticing point of the magnetic force
53: driving motor

| | |
|---|---|
| 54: motor gear | 55: time belt |
| 56: input gear | 57: propulsion shaft |
| 58: propulsion bearing | 59: shaft gear |
| 60: rotational belt | 61: belt fixing part |
| 62: belt support | 63: belt wheel |
| 64: belt gear | 65: middle gear |

66: propulsion member connecting part
67: rotational propulsion member

| | |
|---|---|
| 70: car | 71: storage battery |
| 72: generator | 73: lever hinge |

74: lever node
80: each energy according to a rotation angle of a weighted
81: position of potential energy
82: position of gravity-based kinetic energy
83: position of rotational inertia energy
84: position of mechanical energy
90: rotation radius of lever arm
91: rotation radius of weighted body
92: starting point of levitation of weighted body
93: descending point of weighted body
95: standard point of potential energy of a rotor
96: standard point of potential energy of a weighted body

1. A power-generating apparatus using gravity and magnetic force, the apparatus comprising:
a plurality of driving bodies which are supported by and fixed at either side of a main shaft, and formed into a radial shape;
a plurality of spring housing which are formed in one side of the driving body:
a driving support which is coupled to one side of the spring housing;
a driving spring housing which is formed in one side of the driving support;
a buffer spring which is formed in the spring housing and a driving spring which is formed in the driving spring housing;
a lever arm which is formed in a position in which the spring housing and the driving support are coupled;
rotors each of which is respectively coupled to be fixed to either side of the main shaft;
a lever which is coupled to the lever arm by a hinge, and restrictedly folded and unfolded up in the course of rotation of the rotor;
a lever connecting bar which is coupled to one side of the lever coupled to the lever arm of the both-side rotor, and is integrally formed into a [symbol] shape;
a weighted body which is coupled through a through hole to be maintained, formed into a lengthily extending shape, formed of a magnetic substance and divided into three portions;
two wheels which are inserted into between the portions at a certain interval, protrudes a little and are coupled to be freely rotated;
a magnetic levitation unit which is arranged adjacent to and above the external side of the rotor with an arch shape, and supported by magnetic support frames of either side;
a plurality of magnetic supports which are formed in a center portion of the magnetic levitation and are formed into an arch-curved shape;
a plurality of magnetic fixing parts which are arranged at a certain arrangement between the magnetic supports;
a plurality of magnets which are arranged at a certain arrangement along the magnetic fixing part and the curved surface of the magnetic support;
a rail which is placed in the two magnetic supports along a curved surface of a bottom side of the center portion of the magnetic support;
a driving motor which is mounted on one side of a top portion of the magnetic support;
a time belt which is engaged with a motor gear of the driving motor to rotate;
a propulsion shaft which is fixed to an input gear engaged with the time belt to rotate;
a pair of propulsion bearings which fix and maintain the propulsion shaft at either side;
a pair of shaft gears which are respectively fixed to either side of the propulsion shaft;
a pair of rotational belt each of which is engaged with the shaft gear to rotate; and
a plurality of rotational propulsion members each of which is coupled to an outer side of the rotational belt through a propulsion member connecting part and formed into a ‘L’ shape,
wherein if the weighted body formed of the magnetic substance approaches a starting point of the magnetic force of the magnetic levitation unit in the course of rotation of the rotor, the weighted body is levitated by gravitation of the magnet of the magnetic support adjacent to and above the rotor,
because the gravitation of the magnet gradually becomes weak toward an ending point of the magnetic force of the magnetic support, the weighted body tightly contacting the magnetic support fails downward to descend,
the rotational propulsion member of the rotational belt is rotated by driving the driving motor, one side of the [symbol] shape is supported by the rotational belt, the other side contacts the levitated weighted body to push and move the weighted body, and thus, the folded lever is unfolded,
when the weighted body falls downward, because the driving spring contacts the unfolded lever, the weighted body presses the driving support to descend, and
an unbalance of the left-and-right sides of the rotor occurs by the lever which is folded up and unfolded in the course of rotation of the rotor, and thus, the mains shaft is rotated by a weight difference of the weighted body.

2. The apparatus of claim 1, further comprising:
a shaft gear which is placed at one side of inside the rotational belt, and is coupled to either end of the propulsion shaft rotating by the driving motor;
a pair of belt gears which are placed at the other side of inside the rotational belt, and make the rotational belt engaged with the shaft gear to be supported in left-and-right sides;
a pair of middle gears which are engaged with an inside of a center portion of an upper belt of the rotational belt which is engaged with the shaft gear and the belt gear, thereby making an arch-shaped curved surface be formed; and
a plurality of belt supports which are placed at an outer side of bottom surface of a lower belt of the rotational belt to make an arch-shaped curved surface be formed, and a plurality of belt wheels are placed under the belt support,
wherein an arch shape is formed by the shaft gear, the belt gear and the middle gear,
the belt support placed along the curved surface of the magnetic support is fixed and supported by a belt fixing part, frictional force
is moderated by the belt wheels placed along a curved surface of bottom surface of the rotational belt in the course of rotation, and
the rotational propulsion member with a [symbol] shape is coupled to the rotational belt, and thus, the rotational belt rotates along an arch-shaped curved surface.

3. The apparatus of claim 1, wherein, when the rotor is rotating, the weighted body ascends with the levers of both sides being folded, when the weighted body is being placed at the top, the weighted body is levitated by magnetic force, and thus, a load supported by the rotor is removed, and when the weighted body is being moved to descend by the rotational propulsion member, the lever is unfolded to sequentially and continuously descend, and thus, a power is generated.

4. The apparatus of claim 1, wherein, when the weighted body is levitated to be adjacent to a bottom of the magnetic support, two wheels placed at the weighted body roll on two lines of the rails along a curved surface, thereby the weighted body being moved.

5. The apparatus of claim 1, wherein, the lever, which is coupled to the lever arm by a hinge, comprises a lever node which is formed of a plurality of nodes to be coupled by a hinge, and a plurality of lever hinges which configure a
plurality of hinges, and when the weighted body descends, the lever is restrictedly unfolded, when the weighted body ascends, the lever is restrictedly folded up, in the course of rotation of the rotor.

6. The apparatus of claim 1, wherein the magnet, which is mounted on the magnetic support, is formed of a plurality of electromagnets mounted along an arch-shaped curved surface of the magnetic support.

7. The apparatus of claim 1, wherein,
the rotor, which is fixed to either side of the main shaft to rotate, is restrictedly rotates by the lever and the weighted body in the course of rotation of the rotor,
when the weighted body ascends with the lever being folded up, the lever contacts a buffer spring, and
when the weighted body descends with the lever being unfolded, the lever contacts a driving spring, and thus, a shock generated by a weight of the weighted body is moderated, and the lever presses the driving spring to descend, and thus, the shock generated by a contact between metals is moderated, thereby the rotor being smoothly rotated.

8. The apparatus of claim 1, wherein
a plurality of magnets with one polarity are mounted on a portion of the weighted body, and
magnets with the other polarity opposite to the one polarity are mounted on the magnetic support along a curved surface, the magnets in the weighted body and the magnetic support facing each other.

9. The apparatus of claim 1, wherein each of the propulsion member connecting parts of a plurality of the L-shaped rotational propulsion members is coupled to the rotational belt formed in one line along a curved surface between rails of center of the magnetic support, and the rotational belt rotates the rotational propulsion member.

10. The apparatus of claim 1, wherein a propulsion member connecting part, which is a folded portion of the rotational propulsion members formed into a [symbol] shape, is coupled to a center of the outside of the rotational belt, one side of the [symbol] shape is supported by the rotational belt, and the other side of the [symbol] shape contacts the levitated weighted body to push and continuously move the levitated weighted body in one direction in order for the folded lever to be unfolded.

11. The apparatus of claim 1, wherein magnets are mounted on the magnetic fixing parts and the magnetic supports at a certain arrangement along a curved surface, and the magnetic fixing parts and the magnetic supports are placed to be maximally adjacent to the rotor under the magnetic fixing parts and the magnetic supports in a starting point of the magnetic force,
a gap between the magnetic fixing parts and the magnetic supports and the rotor gradually becomes wider from a starting point of the magnetic force to a ending point of the magnetic force; and
a magnetic force of the magnet gradually becomes weak from the starting point of the magnetic force to the ending point of the magnetic force.

12. The apparatus of claim 1, wherein the driving spring is mounted on a driving spring housing formed in one side of the driving support formed in the edge of the rotor, the driving spring contacts the lever in the course of a descent of the weighted body to moderate a shock generated by a weight of the weighted body, and the driving spring sequentially press the lever to continuously descend, thereby the rotor being smoothly rotated.

13. The apparatus of claim 2, wherein a propulsion member connecting part, which is a folded portion of the rotational propulsion members formed into a [symbol] shape, is coupled to a center of the outside of the rotational belt, one side of the [symbol] shape is supported by the rotational belt, and the other side of the [symbol] shape contacts the levitated weighted body to push and continuously move the levitated weighted body in one direction in order for the folded lever to be unfolded.
